(19) United States
(12) Patent Application Publication
(10) Pub. No.: US 2025/0083626 A1
(43) Pub. Date: Mar. 13, 2025

(54) SYSTEM AND METHOD FOR CONNECTING SEPARATE HIGH VOLTAGE BUSES TO SUPPORT MULTIPLE MODES OF HIGH VOLTAGE ARCHITECTURE OPERATION

(71) Applicant: GM Global Technology Operations LLC, Detroit, MI (US)

(72) Inventors: William R. Cawthorne, Milford, MI (US); Steven V. Wybo, Grosse Pointe Park, MI (US); Suhan Woo, Rochester Hills, MI (US); Dae Young Kim, Madison Heights, MI (US)

(21) Appl. No.: 18/462,764

(22) Filed: Sep. 7, 2023

(51) Int. Cl. B60R 16/023; B60R 16/033

(52) U.S. Cl. CPC B60R 16/0238; B60R 16/033

(57) ABSTRACT

A vehicle includes an electrical system including a method of operating an electrical system. The electrical system includes a first set of devices configured to connect to a power source via a primary bus, a second set of devices configured to connect to the power source via a secondary bus, a connector device between the first set of devices and the second set of devices. A processor circulates a current between the first set of devices and the second set of devices through the connector device.

### INTRODUCTION

The subject disclosure relates to powering an electrical device or set of devices and, in particular, to a method of powering the electrical device that is isolated from a primary power source.

An electrical system, such as an electrical system of a vehicle, can have charging devices, such as an onboard charging module, and electrical components, such as an auxiliary power module. The onboard charging module can be connected to a power source (i.e., a battery) over a first bus, while the electrical components can be connected to the power source over a second bus. When the power source is removed or is unavailable, there no way to operate the electrical components. Accordingly, it is desirable to provide a system and method for powering the electrical components of a vehicle without access to the power source of the vehicle.

### SUMMARY

In one exemplary embodiment, a method of operating an electrical system. A first set of devices of the electrical system is connected to a second set of devices of the electrical system via a connector device, wherein the first set of devices are connectable to a power source via a primary bus and the second set of devices are connectable to the power source via a secondary bus. A current is circulated between the first set of devices and the second set of devices through the connector device.

In addition to one or more of the features described herein, the connector device includes at least one of a diode, a contactor, and a solid-state relay.

In addition to one or more of the features described herein, connecting the first set of devices to the second set of devices via the connector device further includes connecting a positive terminal of the first set of devices to a positive terminal of the second set of devices via a first connector device and connecting a negative terminal of the first set of devices to a negative terminal of the second set of devices via a second connector device.

In addition to one or more of the features described herein, the method further includes circulating the current through one of the first connector device but not the second connector device, the second connector device but not the first connector device, and both the first connector device and the second connector device.

In addition to one or more of the features described herein, the first set of devices includes an onboard charging module of a vehicle, and the second set of devices is an auxiliary power module of the vehicle, further including circulating the current to provide power from the onboard charging module to the auxiliary power module when the onboard charging module and the auxiliary power module are isolated from the power source.

In addition to one or more of the features described herein, the method further includes heating the power source by the second set of devices.

In addition to one or more of the features described herein, the method further includes diagnosing the electrical system by comparing a first voltage across the first set of devices to a second voltage across the second set of devices when one of the first set of devices are energized by the power source and the connector device is forward biased to connect the second set of devices to the power source, and the second set of devices is energized by the power source and the first set of devices are isolated from the power source.

In another exemplary embodiment, an electrical system for a vehicle is disclosed. The electrical system includes a first set of devices configured to connect to a power source via a primary bus, a second set of devices configured to connect to the power source via a secondary bus, a connector device between the first set of devices and the second set of devices, and a processor configured to circulating a current between the first set of devices and the second set of devices through the connector device.

In addition to one or more of the features described herein, the connector device includes at least one of a diode, a contactor, and a solid-state relay.

In addition to one or more of the features described herein, the connector device further includes a first connector device and a second connector device, the processor being further configured to connect a positive terminal of the first set of devices to a positive terminal of the second set of devices via the first connector device and connect a negative terminal of the first set of devices to a negative terminal of the second set of devices via the second connector device.

In addition to one or more of the features described herein, the processor is further configured to circulate the current through one of the first connector device but not the second connector device, the second connector device but not the first connector device, and both the first connector device and the second connector device.

In addition to one or more of the features described herein, the first set of devices includes an onboard charging module, the second set of devices is an auxiliary power module, and the processor is further configured to circulate the current to provide power from the onboard charging module to the auxiliary power module when the onboard charging module and the auxiliary power module are isolated from the power source.

In addition to one or more of the features described herein, the second set of devices is configured to heat the power source.

In addition to one or more of the features described herein, the processor is further configured diagnose the electrical system by comparing a first voltage across the first set of devices to a second voltage across the second set of devices when one of the first set of devices are energized by the power source and the connector device is forward biased to connect the second set of devices to the power source, and the second set of devices is energized by the power source and the first set of devices are isolated from the power source.

In yet another exemplary embodiment, a vehicle is disclosed. The vehicle includes a power source, a first set of devices configured to connect to the power source via a primary bus, a second set of devices configured to connect to the power source via a secondary bus, a connector device between the first set of devices and the second set of devices, and a processor configured to circulate a current between the first set of devices and the second set of devices through the connector device.

In addition to one or more of the features described herein, the connector device includes at least one of a diode, a contactor, and a solid-state relay.

In addition to one or more of the features described herein, the connector device further includes a first connector device and a second connector device, the processor being further configured to connect a positive terminal of the first set of devices to a positive terminal of the second set of devices via the first connector device and connect a negative terminal of the first set of devices to a negative terminal of the second set of devices via the second connector device.

In addition to one or more of the features described herein, the processor is further configured to circulate the current through one of the first connector device but not the second connector device, the second connector device but not the first connector device, and both the first connector device and the second connector device.

In addition to one or more of the features described herein, the first set of devices includes an onboard charging module, the second set of devices is an auxiliary power module, and the processor is further configured to circulate the current to provide power from the onboard charging module to the auxiliary power module when the onboard charging module and the auxiliary power module are isolated from the power source.

In addition to one or more of the features described herein, the second set of devices is configured to heat the power source.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a circuit diagram of the electrical system of the vehicle, in an illustrative embodiment;

FIG. 3 shows a circuit diagram of the electrical system in a first embodiment;

FIG. 4 is a circuit diagram depicting the electrical system in a first mode of operation;

FIG. 5 is a circuit diagram depicting the electrical system in a second mode of operation;

FIG. 6 is a circuit diagram depicting the electrical system in a third mode of operation;

FIG. 7 is a circuit diagram depicting the electrical system in a fourth mode of operation;

FIG. 8 is a circuit diagram depicting the electrical system in a first failure mode of operation;

FIG. 9 is a circuit diagram depicting the electrical system in a second failure mode of operation;

FIG. 10 shows a flowchart of a first method for diagnosing the contactor devices of the electrical system; and

FIG. 11 shows a flowchart of a second method for diagnosing the contactor devices of the electrical system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

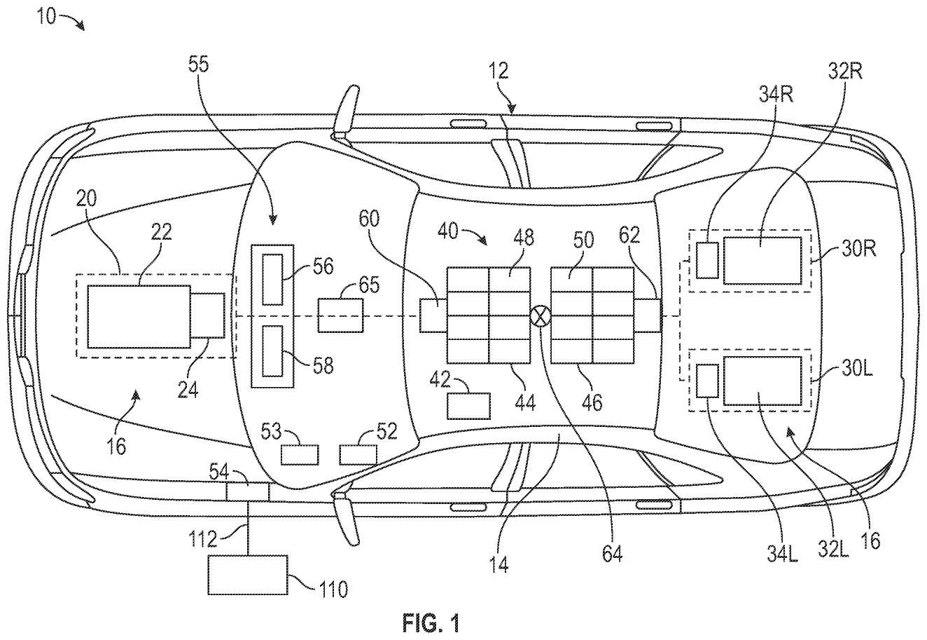

In accordance with an exemplary embodiment, FIG. 1 shows a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes an electric motor 32L and an inverter 34L. A right rear drive unit 30R includes an electric motor 32R and an inverter 34R. The inverters 24, 34L and 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 and rear electric motors 32L and 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives front wheels (not shown) and the rear electric motors 32L and 32R drive rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

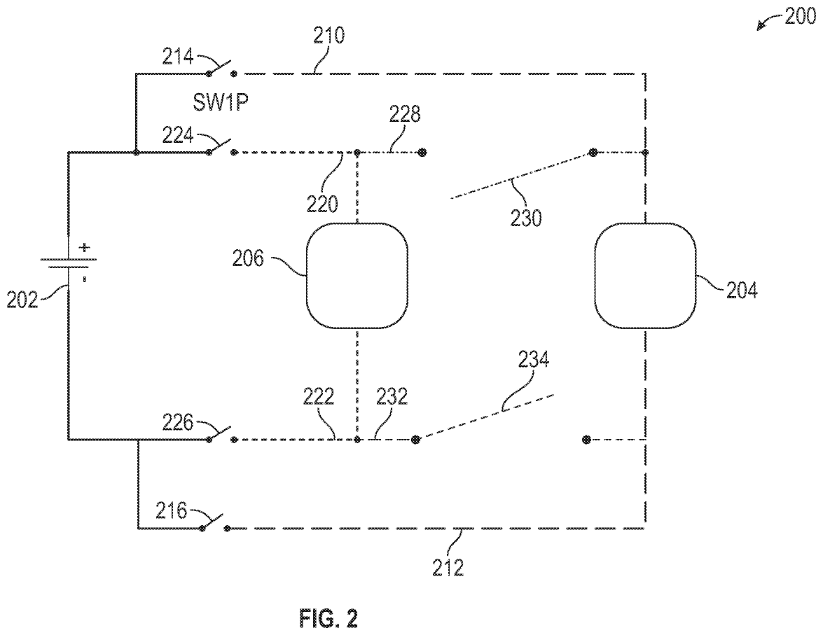

In an embodiment, the battery system 40 includes a plurality of separate battery assemblies, in which each battery assembly can be independently charged and can be used to independently supply power to a drive system or systems. For example, the battery system 40 includes a first battery assembly such as a first battery sub-pack 44 connected to the front inverter 24, and a second battery sub-pack 46. The first battery sub-pack 44 includes a plurality of battery modules 48, and the second battery sub-pack 46 includes a plurality of battery modules 50. Each battery module 48, 50 includes a number of individual cells (not shown). In various embodiments, one or more of the battery packs can include a MODACS (Multiple Output Dynamically Adjustable Capacity) battery, as described herein with respect to FIGS. 2-4.

Each of the front electric motor 22 and the rear electric motors 32L and 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the battery packs 44 and 46, and selectively connecting the battery packs 44 and 46 to the front drive unit 20, left rear drive unit 30L and right rear drive unit 30R. The switching devices may also be operated to selectively connect the first battery sub-pack 44 and the second battery sub-pack 46 to a charging system. The charging system can be used to charge the first battery sub-pack 44 and the second battery sub-pack 46, and/or to supply power from the first battery sub-pack 44 and/or the second battery sub-pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC). As shown in FIG. 1, the utility AC power supply is a charging station 110 that is connected to the charge port 54 via an electric cord 112.

In an embodiment, the switching system includes a first switching device 60 that selectively connects the first battery sub-pack 44 to the inverters 24, 34L and 34R, and a second switching device 62 that selectively connects the second battery sub-pack 46 to the inverters 24, 34L and 34R. The switching system also includes a third switching device 64 (also referred to as a “battery switching device”) for selectively connecting the first battery sub-pack 44 to the second battery sub-pack 46 in series.

Any of various controllers can be used to control functions of the battery system 40, the switching system and the drive units. A controller includes any suitable processing device or unit and may use an existing controller such as a drive system controller, an RESS controller, and/or controllers in the drive system. For example, a controller 65 may be included for controlling switching and drive control operations as discussed herein.

The controller 65 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 65 may include a non-transitory computer-readable medium that stores instructions which, when processed by one or more processors of the controller 65, implement a method of charging a battery, according to one or more embodiments detailed herein. Such method includes operating various control blocks and switches of the vehicle, as discussed herein.

The methods disclosed herein are discussed for use in operating a vehicle. However, the methods are not meant to be limited to a vehicle. In various embodiments, the methods can be used to operate any suitable electrical system.

FIG. 2 shows a circuit diagram of the electrical system 200 of the vehicle 10, in an illustrative embodiment. The electrical system 200 includes a power source 202, a first set of devices 204 and a second set of devices 206. The power source 202 can be a voltage source, a battery, a battery pack, a set of batteries, etc. The first set of devices 204 can includes electrical components, such as on-board charging module, an inverter of the motor, a high voltage heater, a high voltage air conditioner, etc. The second set of devices 206 can include an auxiliary power module as well as other electrical components.

The power source 202 is connected to the first set of devices 204 via a primary bus that includes a primary positive bus 210 and a primary negative bus 212. The primary positive bus 210 connects a positive terminal of the power source 202 to a positive terminal of the first set of devices 204 and includes a first primary loop switch 214. The primary negative bus 212 connects a negative terminal of the power source 202 to a negative terminal of the first set of devices 204 and includes a second primary loop switch 216.

Similarly, the power source 202 is connected to the second set of devices 206 via a secondary bus that includes a secondary positive bus 220 and a secondary negative bus 222. The secondary positive bus 220 connects a positive terminal of the power source 202 to a positive terminal of the second set of devices 206 and includes a first secondary loop switch 224. The secondary negative bus 222 connects a negative terminal of the power source 202 to a negative terminal of the second set of devices 206 and includes a second secondary loop switch 226.

A first auxiliary branch 228 connects the positive terminal of the first set of devices 204 to the positive terminal of the second set of devices 206. The first auxiliary branch 228 includes a first connector device 230 between the first set of devices 204 and the second set of devices 206.

Similarly, a second auxiliary branch 232 connects the negative terminal of the first set of devices 204 to the negative terminal of the second set of devices 206. The second auxiliary branch 232 includes a second connector device 234 between the first set of devices 204 and the second set of devices 206.

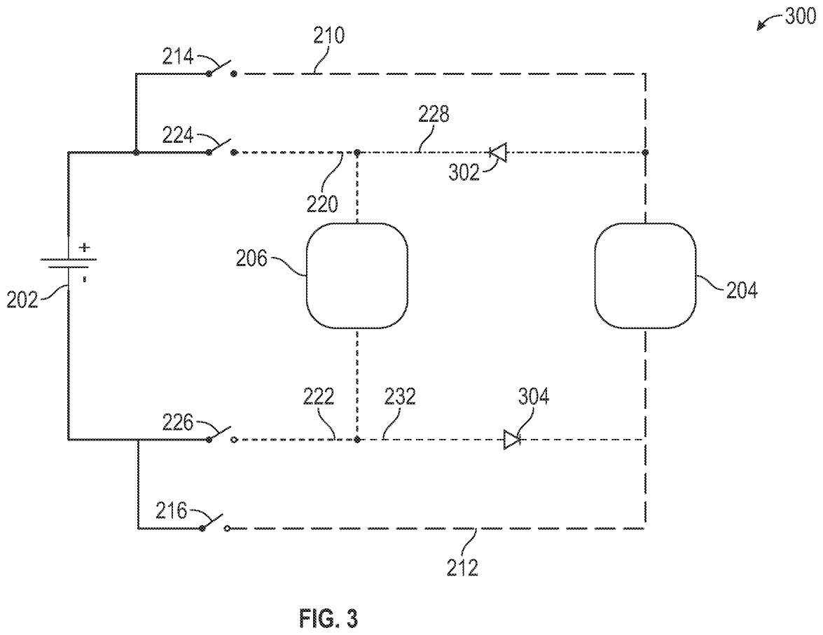

FIG. 3 shows a circuit diagram 300 of the electrical system 200 in a first embodiment. The first connector device is a first diode 302 that controls flow of current in the direction from the positive terminal of the first set of devices 204 to the positive terminal of the second set of devices 206. The second connector device is a second diode 304 that controls flow of current in the direction from the negative terminal of the second set of devices 206 to the negative terminal of the first set of devices 204. In alternative embodiments, the connector devices can be switches, contactors, solid-state relays, etc.

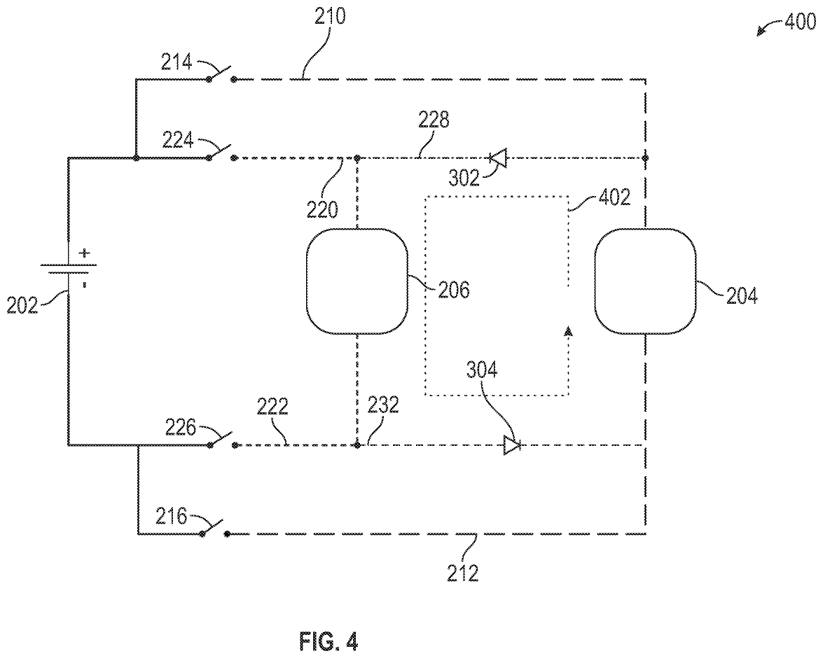

FIG. 4 is a circuit diagram 400 depicting the electrical system 200 in a first mode of operation. The first mode of operation is a normal (functional) mode of operation. The first primary loop switch 214 and the second primary loop switch 216 are open, and the first secondary loop switch 224 and the second secondary loop switch 226 are open. Thus, the primary current loop is not established (i.e., the first set of devices 204 is isolated from the power source 202) and the secondary loop is not established (i.e., the second set of devices 206 is isolated from the power source). However, a voltage difference across the first set of devices 204 forward biases the first diode 302 and the second diode 304, thereby creating a free current loop 402 through the first diode, the secondary set of devices 206 and the second diode to power the secondary set of devices 206. Since the first set of devices 204 includes an onboard control module 52, 53 and the second set of devices 206 includes the auxiliary power module 42 onboard control module can provide power to the auxiliary power module. In an embodiment, the secondary set of devices 206 can include an electrically powered pump that can pump a coolant through the power source 202 to warm the power source 202. In a cold environment, the power source 202 can be at a temperature at which it is unable to operate. By operating the pump via the free current loop 402, the temperature of the power source 202 can be raised to a temperature at which it can operate. The pump can be powered by the auxiliary power module 42. At least one of the first set of devices 204 and the second set of devices 206 can include an electrically powered heater to warm the coolant so that the coolant is further able to raise the temperature of the power source 202.

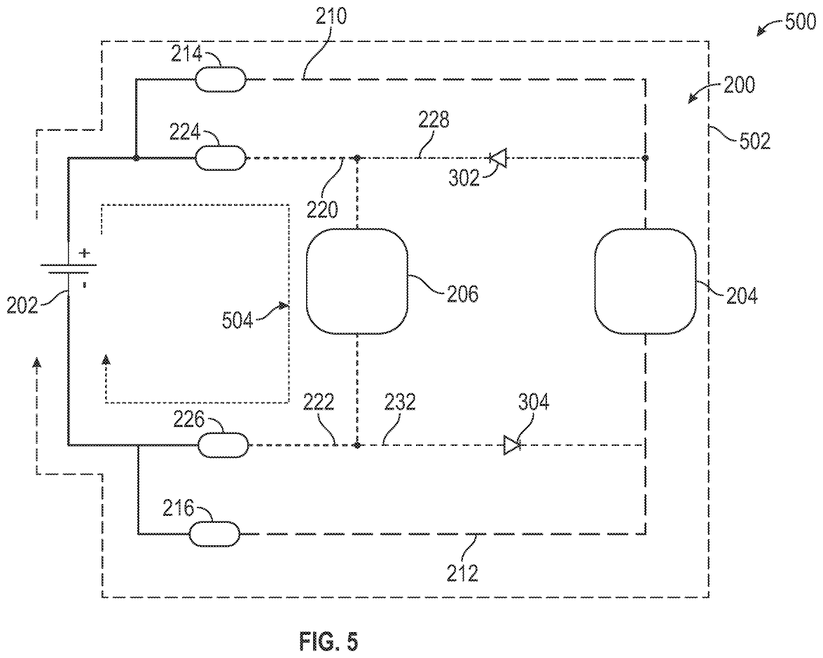

FIG. 5 is a circuit diagram 500 depicting the electrical system 200 in a second mode of operation. The second mode of operation is a normal mode of operation. A primary current loop 502 is established (i.e., the first primary loop switch 214 and the second primary loop switch 216 are closed) and a secondary current loop 504 is established (i.e., the first secondary loop switch 224 and the second secondary loop switch 226 are closed). In this mode, there is no voltage difference and thus no forward biasing across the first diode 302. Thus, no current flow through the first diode 302 and the first auxiliary branch 228 can be considered as removed from the circuit. Similarly, there is no voltage difference and thus no forward biasing across the second diode 304. Thus, no current flows through the second diode 304 and the second auxiliary branch 232 can be considered as removed from the circuit.

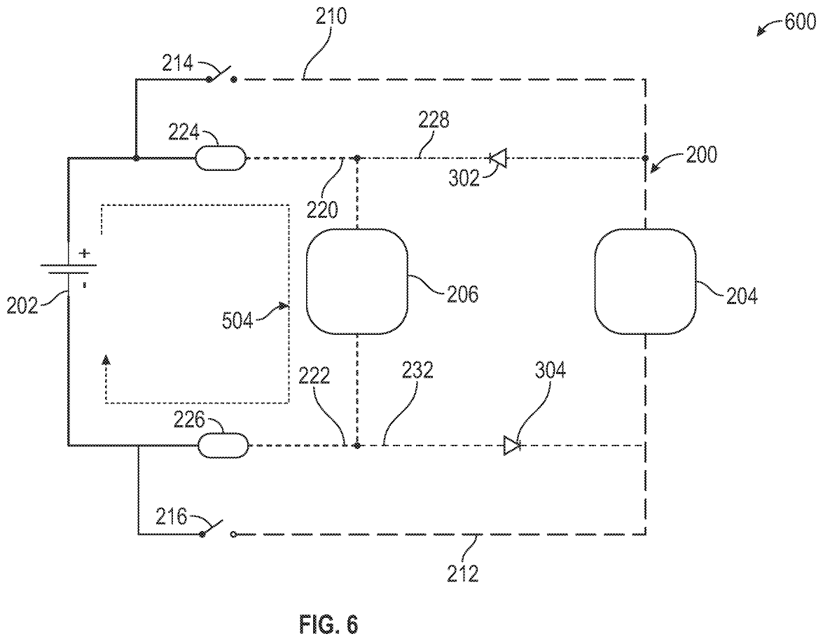

FIG. 6 is a circuit diagram 600 depicting the electrical system 200 in a third mode of operation. The third mode of operation is used to power the second set of devices 206 (and thus the auxiliary power module) via the power source 202. The first primary loop switch 214 and the second primary loop switch 216 are open. Thus, the primary loop 502 (FIG. 5) is not established. The first secondary loop switch 224 and the second secondary loop switch 226 are closed, thereby allowing current to flow through the secondary current loop 504.

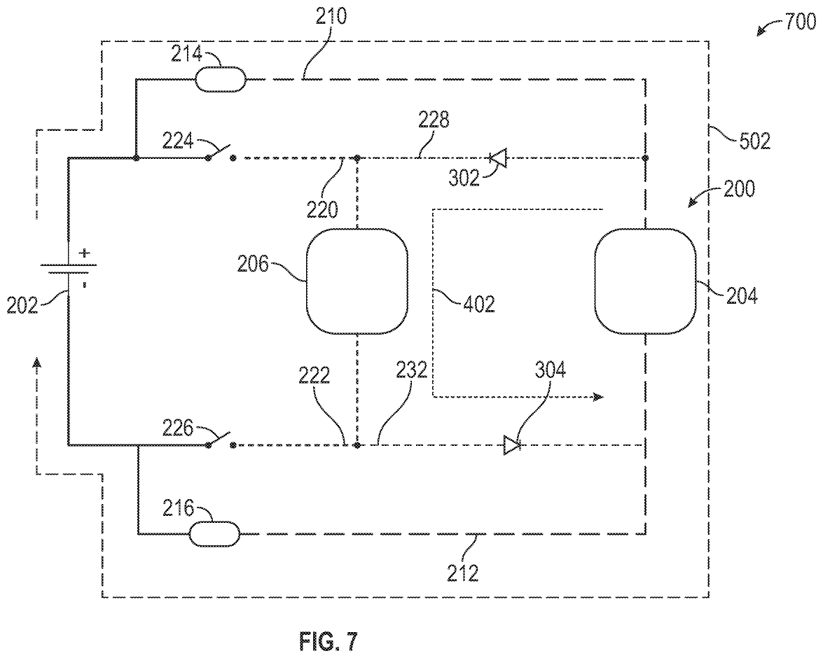

FIG. 7 is a circuit diagram 700 depicting the electrical system 200 in a fourth mode of operation. The fourth mode of operation can be used to reduce a contactor cycle in the first connector device (e.g., first diode 302) and the second connector device (e.g., second diode 304). The first primary loop switch 214 and the second primary loop switch 216 are closed, thereby allowing current to flow through the primary current loop 502. The first secondary loop switch 224 and the second secondary loop switch 226 are open. Thus, no current flows through the secondary current loop 504 (FIG. 6). Due to the configuration of the switches, a voltage difference exists across the first diode 302 and the second diode 304, thereby forward biasing the diodes and allowing a current 402 to flow through the first auxiliary branch 228 and the second auxiliary branch 232, respectively.

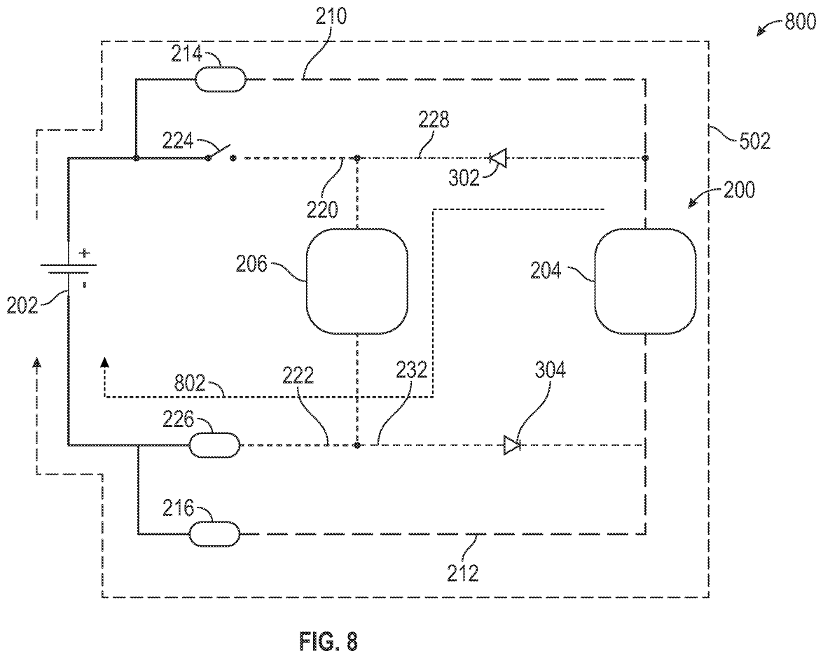

FIG. 8 is a circuit diagram 800 depicting the electrical system 200 in a first failure mode of operation. The first primary loop switch 214 and the second primary loop switch 216 are closed, thereby allowing first auxiliary current 802 to flow through the primary current loop 502. The first secondary loop switch 224 is open due to a failure, while the second secondary loop switch 226 is closed. Therefore, the secondary current loop is not established. However, a first auxiliary current 802 can flow through the first diode 302, the second set of devices 206, and the second secondary loop switch 226 to power the second set of devices.

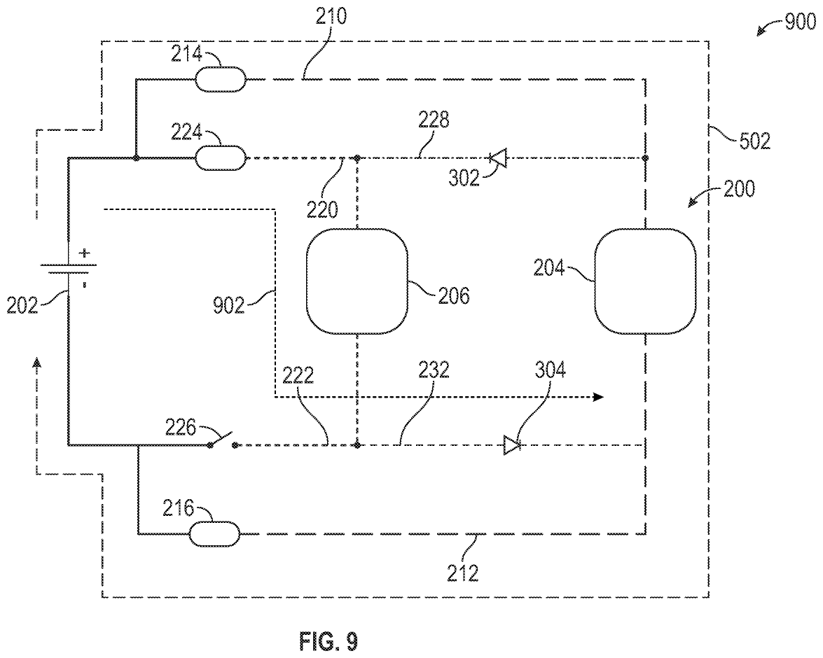

FIG. 9 is a circuit diagram 900 depicting the electrical system 200 in a second failure mode of operation. The first primary loop switch 214 and the second primary loop switch 216 are closed, thereby allowing current to flow through the primary current loop 502. The first secondary loop switch 224 is closed, while the second secondary loop switch 226 is open due to a failure. Therefore, no current flows through the secondary current loop 504 (FIG. 6). However, a second auxiliary current 902 can flow through the first secondary loop switch 224, the second set of devices 206, and the second diode 304 to power the second set of devices.

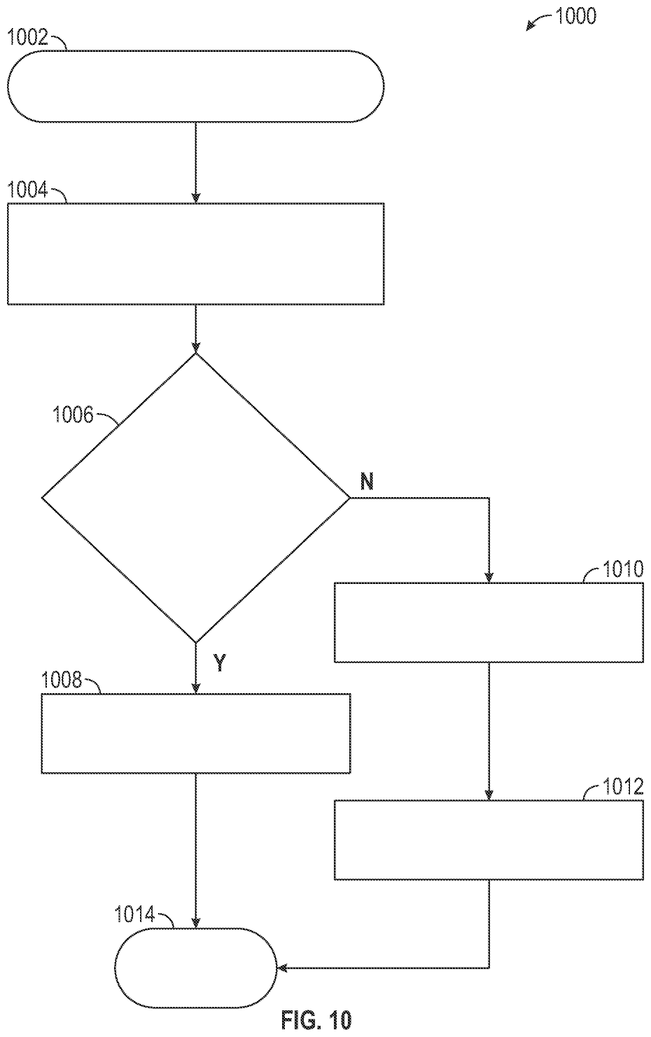

FIG. 10 shows a flowchart 1000 of a first method for diagnosing the contactor devices of the electrical system 200. The method begins at box 1002 in which the primary loop switches and second loop switches are in an open position. In box 1004, the primary voltage loop is energized (close the first primary loop switch 214 and the second primary loop switch 216) while leaving the second voltage loop disconnected from the power source 202. In box 1006 a first voltage across the primary voltage loop is compared to a second voltage across the secondary voltage loop. If the first voltage is equal to the second voltage within a selected threshold, the method proceeds to box 1008. Otherwise, the method proceeds to box 1010.

In box 1008, a signal is generated to indicate that the electrical system passes the diagnostic test. The method then proceeds to box 1014 where the method ends. In box 1010, a signal is generated to indicate that the electrical system has failed the diagnostic test. In box 1012, an appropriate remedial action is taken. In box 1014, the method ends.

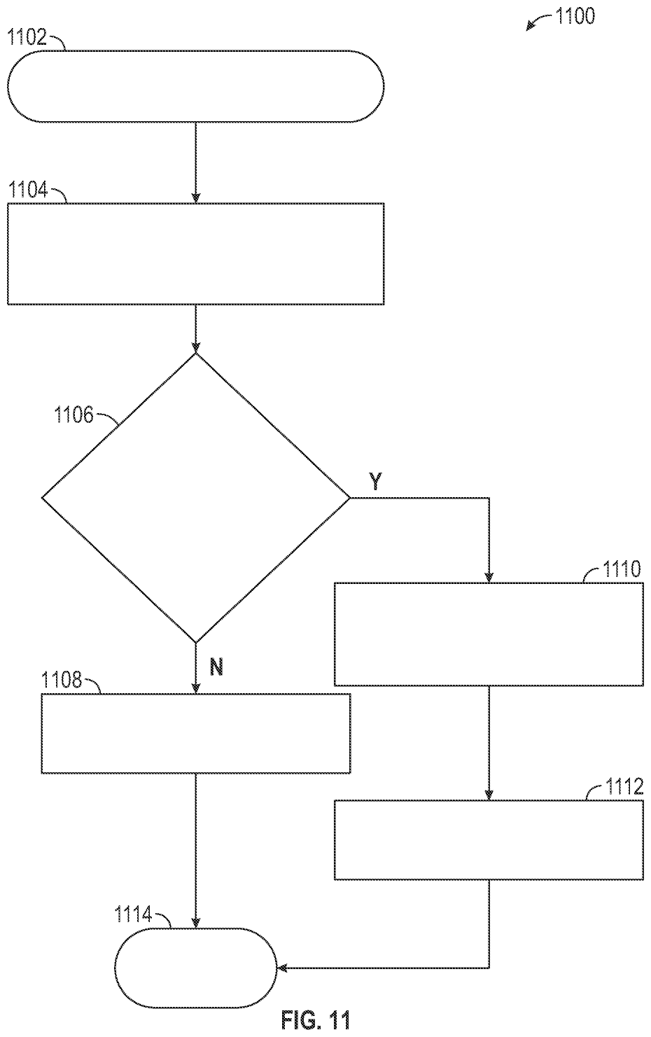

FIG. 11 shows a flowchart 1100 of a second method for diagnosing the contactor devices of the electrical system 200. The method begins at box 1102 in which the switches primary loop switches and second loop switches are in an open position. In box 11004, the secondary voltage loop is energized (close the first secondary loop switch 224 and the second secondary loop switch 226) while leaving the first voltage loop disconnected from the power source 202. In box 1106 a first voltage across the primary voltage loop is compared to a second voltage across the secondary voltage loop. If the first voltage is equal to the second voltage within a selected threshold, the method proceeds to box 1108. Otherwise, the method proceeds to box 1110.

In box 1108, a signal is generated to indicate that the electrical system passes the diagnostic test. The method then proceeds to box 1114 where the method ends. In box 1110, a signal is generated to indicate that the electrical system has not passed the diagnostic test. In box 1112, an appropriate remedial action is taken. In box 1014, the method ends.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating an electrical system, comprising:
connecting a first set of devices of the electrical system to a second set of devices of the electrical system via a connector device, wherein the first set of devices are connectable to a power source via a primary bus and the second set of devices are connectable to the power source via a secondary bus; and
circulating a current between the first set of devices and the second set of devices through the connector device.

2. The method of claim 1, wherein the connector device includes at least one of: (i) a diode; (ii) a contactor; and (iii) a solid-state relay.

3. The method of claim 1, wherein connecting the first set of devices to the second set of devices via the connector device further comprises connecting a positive terminal of the first set of devices to a positive terminal of the second set of devices via a first connector device and connecting a negative terminal of the first set of devices to a negative terminal of the second set of devices via a second connector device.

4. The method of claim 3, further comprising circulating the current through one of: (i) the first connector device but not the second connector device; (ii) the second connector device but not the first connector device; and (iii) both the first connector device and the second connector device.

5. The method of claim 1, wherein the first set of devices includes an onboard charging module of a vehicle, and the second set of devices is an auxiliary power module of the vehicle, further comprising circulating the current to provide power from the onboard charging module to the auxiliary power module when the onboard charging module and the auxiliary power module are isolated from the power source.

6. The method of claim 1, further comprising heating the power source by the second set of devices.

7. The method of claim 1, further comprising diagnosing the electrical system by comparing a first voltage across the first set of devices to a second voltage across the second set of devices when one of: (i) the first set of devices are energized by the power source and the connector device is forward biased to connect the second set of devices to the power source; and (ii) the second set of devices is energized by the power source and the first set of devices are isolated from the power source.

8. An electrical system for a vehicle, comprising:
a first set of devices configured to connect to a power source via a primary bus;
a second set of devices configured to connect to the power source via a secondary bus;
a connector device between the first set of devices and the second set of devices; and
a processor configured to circulating a current between the first set of devices and the second set of devices through the connector device.

9. The electrical system of claim 8, wherein the connector device includes at least one of: (i) a diode; (ii) a contactor; and (iii) a solid-state relay.

10. The electrical system of claim 8, wherein the connector device further comprises a first connector device and a second connector device, the processor being further configured to connect a positive terminal of the first set of devices to a positive terminal of the second set of devices via the first connector device and connect a negative terminal of the first set of devices to a negative terminal of the second set of devices via the second connector device.

11. The electrical system of claim 10, wherein the processor is further configured to circulate the current through one of: (i) the first connector device but not the second connector device; (ii) the second connector device but not the first connector device; and (ii) both the first connector device and the second connector device.

12. The electrical system of claim 8, wherein the first set of devices includes an onboard charging module, the second set of devices is an auxiliary power module, and the processor is further configured to circulate the current to provide power from the onboard charging module to the auxiliary power module when the onboard charging module and the auxiliary power module are isolated from the power source.

13. The electrical system of claim 8, wherein the second set of devices is configured to heat the power source.

14. The electrical system of claim 8, wherein the processor is further configured diagnose the electrical system by comparing a first voltage across the first set of devices to a second voltage across the second set of devices when one of: (i) the first set of devices are energized by the power source and the connector device is forward biased to connect the second set of devices to the power source; and (iii) the second set of devices is energized by the power source and the first set of devices are isolated from the power source.

15. A vehicle, comprising:
a power source;
a first set of devices configured to connect to the power source via a primary bus;
a second set of devices configured to connect to the power source via a secondary bus;
a connector device between the first set of devices and the second set of devices; and
a processor configured to circulate a current between the first set of devices and the second set of devices through the connector device.

16. The vehicle of claim 15, wherein the connector device includes at least one of: (i) a diode; (ii) a contactor; and (iii) a solid-state relay.

17. The vehicle of claim 15, wherein the connector device further comprises a first connector device and a second connector device, the processor being further configured to connect a positive terminal of the first set of devices to a positive terminal of the second set of devices via the first connector device and connect a negative terminal of the first set of devices to a negative terminal of the second set of devices via the second connector device.

18. The vehicle of claim 17, wherein the processor is further configured to circulate the current through one of: (i) the first connector device but not the second connector device; (ii) the second connector device but not the first connector device; and (iii) both the first connector device and the second connector device.

19. The vehicle of claim 15, wherein the first set of devices includes an onboard charging module, the second set of devices is an auxiliary power module, and the processor is further configured to circulate the current to provide power from the onboard charging module to the auxiliary power module when the onboard charging module and the auxiliary power module are isolated from the power source.

20. The vehicle of claim 15, wherein the second set of devices is configured to heat the power source.
